(19) United States
(12) Patent Application Publication
(10) Pub. No.: US 2025/0313510 A1
(43) Pub. Date: Oct. 9, 2025

(54) METHOD FOR PREPARING LIGHTWEIGHT AGGREGATES

(71) Applicant: SEEGEX, Fontaine-la-Mallet (FR)

(72) Inventor: David Claude GAMBIER, Fontaine-la-Mallet (FR)

(73) Assignee: SEEGEX, FONTAINE-LA-MALLET (FR)

(21) Appl. No.: 18/712,418

(22) PCT Filed: Nov. 21, 2022
(86) PCT No.: PCT/EP2022/082630

§ 371 Date: Oct. 10, 2024

(30) Foreign Application Priority Data
Nov. 22, 2021 (FR) 2112330

(51) Int. Cl. C04B 18/02; C04B 18/04; C04B 20/04; C04B 111/00; C04B 111/40

(52) U.S. Cl. CPC C04B 18/021; C04B 18/027; C04B 18/0418; C04B 18/0436; C04B 20/04; C04B 2111/0075; C04B 2111/40

(57) ABSTRACT

A method for preparing lightweight clay-based aggregates, the aggregates being suitable for use notably in civil engineering works, in particular road uses, and construction. The method for preparing lightweight aggregates includes at least the following steps: a) a step of granulating a clay-based mixture, so as to obtain aggregates, b) a step of drying the aggregates obtained, so as to obtain dried aggregates, c) a step of heat treatment of the dried aggregates, this step having two successive substeps: i) a first substep of heat treatment carried out under a reducing atmosphere at a temperature Ti of between 900° C. and 1200° C. approximately, ii) a second substep of heat treatment carried out under an oxidizing atmosphere at a temperature T2 of between 1050° C. and 1300° C. approximately, and d) a step of cooling the aggregates.

### FIELD

The object of the present invention is a method for preparing light clay-based aggregates, said aggregates being adapted for use especially in public works, in particular road uses, and construction.

### BACKGROUND

Industrial waste, such as especially the sludge produced by urban or industrial wastewater treatment plants, contains organic matter, minerals containing a greater or lesser fraction of clays fines, metals and possibly toxic pollutants. This waste represents a very large volume and many methods are directed to its treatment and reclamation.

There is therefore a constant need to develop methods for reclaiming industrial waste, while producing materials of interest for industry or for any other use.

Reclamation of waste, especially sludge and industrial by-products, implies that they be considered inert, that is, that they do not decompose, burn, produce a physical or chemical reaction or deteriorate other materials in contact therewith in a way that is harmful to the environment or human health.

European Standard NF X 30-402-2 specifies a compliance test providing information on the leaching of fragmented waste and sludge under defined experimental conditions. This European standard relates to the characterisation of waste, and especially compliance for the leaching of fragmented waste and sludge. Thus, the leachable fractions of a number of elements or chemical compounds should not exceed certain concentration thresholds set by current regulations, especially the guide values defined by CEREMA (Centre for Studies on Risks, the Environment, Mobility and Urban Planning). As an indication, the permissible limits as defined in the regulations for inert waste storage facilities (ISDI) (appendix II to the Order of December 2014) are shown in Table 1 below, in mg/Kg of dry matter:

TABLE 1

| | ISDI |
|---|---|
| Parameters | guide values |
| LEACHING TESTS (Standard NF X 30-402-2) - | 10 |
| L-S = 10 L/kg | |
| Arsenic (As) | 0.5 |
| Barium (Ba) | 20 |
| Cadmium (Cd) | 0.04 |
| Total chromium (total Cr) | 0.5 |
| Copper (Cu) | 2 |
| Mercury (Hg) | 0.01 |
| Molybdenum (Mo) | 0.5 |
| Nickel (Ni) | 0.4 |
| Lead (Pb) | 0.5 |
| Antimony (Sb) | 0.06 |
| Selenium (Se) | 0.1 |
| Zinc (Zn) | 4 |
| Chlorides (3) | 800 |
| Fluorides | 10 |
| Sulphates (3) | 1000 |
| Phenol index | 1 |
| Total organic carbon (TOC) on eluate (1) | 500 |
| Soluble fraction (3) (FS) | 4000 |
| TESTS ON RAW WASTE | |
| Total organic carbon (TOC) | 30,000 |
| Benzene, Toluene, Ethylbenzene and Xylenes (BTEX) | 6 |
| Polychlorinated biphenyls 7 congeners (PCB) | 1 |
| C₁₀ to C₄₀ Hydrocarbons (HCT) | 500 |
| Polycyclic aromatic hydrocarbons (PAHs) | 50 |
| Dryness (%) | 30 |

Patent application EP-A1-1,571,135 describes a method for manufacturing expanded clay aggregates comprising a fraction of materials originating from organic sludge. This method includes a first heat treatment step carried out at a temperature of 500 to 750° C., enabling the removal of organic matter and the volume expansion of the aggregate, and a second heat treatment step carried out at a temperature of 900 to 1200° C., said second step enabling, on the one hand, the final expansion of the volume of the aggregate and, on the other hand, the acquisition of a definitive cohesion of the aggregate by a eutectic effect between the respective mineral fractions of the clay and the sludge. However, this method is not entirely satisfactory in that it does not produce aggregates in accordance with current regulations, especially because the leachable fractions of some elements or chemical compounds obtained from aggregates prepared according to said method exceed the concentration thresholds set by Standard NF X 30-402-2.

There is therefore a need for a method for preparing lightweight aggregates from a clay-based mixture. By “clay”, it is meant clay mineral matter. By “clay-based mixture”, it is meant a clay product consisting mainly of waste from the water treatment, waterway and port dredging industries, as well as the civil engineering and public works industries. There is a need for a method enabling the drawbacks of the method of prior art to be overcome, and in particular resulting in aggregates that are acceptable from a regulatory point of view.

### SUMMARY

Thus, a first object of the invention is a method for preparing lightweight aggregates comprising at least the following steps:
a) a step of granulating a clay-based mixture to obtain aggregates,
b) a step of drying the aggregates obtained, to obtain dried aggregates,
c) a step of heat treating the dried aggregates, said step comprising two successive sub-steps:
   i) a first heat treatment sub-step carried out in a reducing atmosphere at a temperature T1 of between about 900 and 1200° C.,
   ii) a second heat treatment sub-step carried out in an oxidising atmosphere at a temperature T2 of between about 1050 and 1300° C., and
d) a step of cooling the aggregates.

According to a particular embodiment of the present invention, each of the heat treatment steps is carried out in a rotary furnace, preferably the residence time of the product in the furnace is adjustable by controlling the rotation speed of the furnace and therefore the aggregates drive speed.

According to the method in accordance with the present invention, carrying out said two heat treatment sub-steps, in this order, makes it possible, surprisingly, to remove a very large proportion of the leachable fractions of a number of chemical elements or compounds and thus to obtain aggregates in which the concentration of a very large majority of these chemical elements and compounds is below the concentration thresholds set by the regulations. Indeed, the first heat treatment sub-step carried out in a reducing atmosphere, enables the heavy metals contained in the matrix to be extracted under defined temperature conditions, as they are first reduced and then extracted in the gas phase. Similarly, decomposition of sulphates is only possible in this temperature range under a reducing atmosphere. The second sub-step, under an oxidising atmosphere, additionally enables some metallic pollutants to be blocked in the mineral matrix as insoluble compounds such as spinel-type compounds.

A method according to the invention has the advantage of producing lightweight aggregates from a material comprising metallic and organic pollutants. By “organic pollutants” and “metallic pollutants”, it is meant respectively the organic or metallic elements which are harmful to the environment or human health when they are present in an amount exceeding the concentration thresholds set by Standard NF X 30-402-2.

Thus, the method according to the invention produces a depolluted aggregate. Indeed, the implementation of the method according to the invention leads to the destruction of organic matter, the thermal destruction of pathogenic agents such as bacteria and viruses, the extraction of heavy metals such as mercury, cadmium, lead and zinc and the partial or total decomposition of sulphates and carbonates. The implementation of this method does not result in trapping these pollutants into the aggregates.

In particular, the aggregates prepared by means of the method according to the invention have the great advantage of being depolluted, that is, reclaimable as substitutes for raw materials according to the standards in force, compared with non-heat-treated aggregates, for at least one, and preferably several, of the following elements:
the metals arsenic (As), barium (Ba), cadmium (Cd), total chromium (total Cr), copper (Cu), mercury (Hg), molybdenum (Mo), nickel (Ni), lead (Pb), antimony (Sb), selenium (Se), zinc (Zn), and/or
chlorides, fluorides, sulphates, and/or
the phenol index.

Extraction efficiency can reach 99% effectiveness depending on the pollutants.

A method according to the invention makes it possible to reduce the concentration of pollutants in the leachates by at least 95% compared with their initial concentration, in particular the concentration has been reduced by:
99.6% for copper and its compounds
97.6% for nickel
99.6% for zinc
99.9% for organic compounds
95.9% for sulphates

Particularly, the aggregates prepared by the method according to the invention are depolluted of sulphates. The level of depollution of the aggregates for these elements can be demonstrated by means of leaching tests carried out according to standard NF X 30-402-2, with L/S=10 L/Kg. Aggregates prepared by means of the method according to the invention also have the great advantage of being depolluted, that is, in practice they are reclaimable, compared with non-heat-treated aggregates, for at least one, and preferably several, of the following elements:
Total Organic Carbon (TOC),
benzene, toluene, ethylbenzene and xylenes (BTEX),
Polychlorinated biphenyls 7 congeners (PCB),
hydrocarbons (HCT), and
polycyclic aromatic hydrocarbons (PAHs).

The sum of these different pollutants can reach 30% by mass in the clay-based mixture before treatment.

The level of depollution of the aggregates for these elements, that is, the effectiveness of the treatment obtained by a method according to the invention, can be demonstrated by means of leaching tests on raw waste, as described in standard NF-X-30-402-2.

The chemical and physical characteristics of an aggregate obtained by the method according to the invention make this method adapted for the preparation of a material intended for different uses, especially in the field of public works and construction.

The method according to the invention has the advantage of enabling the production of lightweight aggregates from a clay-based mixture comprising between 5% and 30%, between 10% and 30%, or between 20% and 30% by mass of polluting elements. A method according to the invention further has the advantage of enabling the reclamation of a large volume of industrial waste, as it enables lightweight aggregates to be prepared from a clay-based mixture including a large proportion of industrial sludge and by-products.

The method according to the invention has the advantage of being possibly energy-saving. Indeed, according to a particular implementation of a method according to the invention, the energy required for drying the aggregates can be recovered during the method, for example when cooling the aggregates after their heat treatment. In addition, according to a particular embodiment of a method according to the invention, the first heat treatment sub-step, carried out in a reducing atmosphere, is autothermal. Indeed, in this embodiment, the energy required is supplied by the decomposition and partial combustion of the organic compounds present in the clay-based mixture. The synthesis gas thus produced feeds a recovery boiler ensuring complete combustion of the gas and energy recovery. The energy is recovered in the form of hot air or steam according to the needs of the process.

In addition, the temperature difference between the first and second heat treatment steps may be small, which contributes to limiting the fossil energy consumption of the method compared with other treatment methods.

In a method according to the invention, the heat treatment step under reducing conditions also makes it possible to considerably reduce the volumes of fumes to be treated, compared with methods in the state of the art, and allows their reclamation for other applications.

In addition, compared with methods of prior art, the heat treatment step under oxidising conditions requires very little gas, the natural gas requirement being divided by about 10 compared with a conventional method for producing aggregates from noble clay, which contributes to a reduction in the carbon footprint of the method.

Finally, the method according to the invention is staged, as the different reactors can be separated, which makes it possible to optimise each of the steps in a completely independent manner, whether it be the temperature, the atmosphere or the residence time of the aggregates in the reactor.

By “lightweight aggregates”, it is meant aggregates whose density is less than 1, preferably between 0.6 and 0.95, more preferably about 0.8. The aggregates prepared by a method according to the invention are porous, hard and resistant.

The aggregate produced by a method according to the invention is reclaimable in the construction industry, public works, landscaping and agriculture.

Other advantages and characteristics of a method according to the invention will become apparent upon examining the detailed description of the invention and of different embodiments, which are given by way of illustration and not to limit the scope of the invention. Where ranges of values are indicated, these include the value of the lower and upper bounds.

### DETAILED DESCRIPTION

The method according to the invention comprises a first step a) of granulating a clay-based mixture. Said clay-based mixture consists of a mixture of different materials, each material containing a greater or lesser fraction of clay and organic matter, said materials being homogeneously mixed according to the techniques known to a person skilled in the art.

A material usable in the method according to the invention may comprise:
so-called “noble” clay, originating especially from clay quarries, and/or clay present in a clay material originating from sludge and industrial by-products, said clay material being preferably selected from: a clay sediment from dredging, fines from washing polluted soil, a filter cake, said cake originating from treatment of liquid waste after centrifugation or passage through a filter press, sludge originating from Waste Water Treatment Plants (WWTP sludge), sludge from Urban Waste Water Treatment Plants (UWWTP).

A clay-based mixture usable in a method according to the invention comprises in particular between 10 and 90% clay expressed by weight relative to the weight of dry matter. In a clay-based mixture usable in a method according to the invention, the clay is present due, on the one hand, to the presence of so-called “noble” clay and/or, on the other hand, to the presence of at least one polluted material comprising clay. More particularly, a clay-based mixture usable in a method according to the invention comprises between 10 and 90% clay expressed by weight relative to the weight of dry matter.

Preparing a clay material likely to being incorporated into a clay-based mixture during step a) of the method according to the invention can especially comprise preparing a clay matrix in a plastic state by the incorporation of liquid, in an amount sufficient to obtain a moisture content of between 30% and 50%, preferably 40%. This liquid is preferably water, but can also be chosen from industrial water, waste water or leachates. According to particular embodiments of the invention, one or more additives, in liquid or solid form, may also be added to the clay material.

The additives likely to be added during the method according to the invention are intended to facilitate some chemical reactions or improve the mechanical characteristics of the lightweight aggregate. They are for example:
barium carbonate, which neutralises sulphates,
fixed carbon, which makes it possible to extract some heavy metals and reinforces the reducing nature of the atmosphere.

An organic matter incorporated into a clay-based mixture used during step a) of the method according to the invention originates especially from a material chosen from sludge and industrial by-products. Preferably, this material is chosen from sludge from waste water treatment plants (WWTP sludge), or sludge from urban waste water treatment plants (UWWTP).

According to a more particular implementation of a method according to the invention, said clay-based mixture comprises (i) between 10 and 25%, and preferably 20%, of noble clay material and (ii) at least one material obtained from sludge and industrial by-products, said material being chosen from:
organic sludge, such as sewage plant sludge,
a dredging sediment,
a filter cake, and
a combination of said materials,

said material having been freed from any foreign matter beforehand, such as stones, sea shells and pieces of wood . . . .

Even more particularly, in an implementation of a method according to the invention, said clay-based mixture is obtained by mixing 20% noble clay, 40% dredging sediments of clay nature and 40% WWTP sludge. Said WWTP sludge comprises up to 40% organic matter, that is, between 1% and 40% organic matter, preferably between 20% and 30% organic matter. In this particular case, the organic matter content of such a clay-based mixture is in the order of 8 to 12%.

A clay-based mixture usable in a method according to the invention preferably comprises between 5% and 40% by weight of organic dry matter, expressed as a percentage relative to the total dry weight, more particularly between 10% and 30% by weight of organic dry matter. By “organic dry matter”, it is meant carbon or nitrogen compounds which, when heated to a high temperature, lead to off-gas whose emission contributes to the particular porosity of the material obtained.

Said organic material is also preferably freed from any foreign bodies, especially stones, pieces of wood and plastic. It is then preferably ground and mixed to obtain a homogeneous mixture. One or more additives, in liquid or solid form, may also be added to said organic matter.

In a method according to the invention, said organic material may optionally consist of sludge and industrial by-products from different origins, which are then mixed or combined together.

Preparing a clay-based mixture usable in step a) of the method according to the invention comprises homogeneously mixing the materials. The moisture content of the clay-based mixture can be adapted by the addition of liquid in an adapted amount, preferably to obtain a water content of between 30% and 50%, preferably about 40%. In particular, the moisture content of the mixture can be adjusted by adding a suitable amount of water, industrial water, waste water or leachate. One or more additives, in liquid or solid form, may also be added to said clay-based mixture.

According to a particular embodiment of the method according to the invention, the method does not comprise the addition of additives.

According to a particular aspect of the method according to the invention, step a) of granulating the clay-based mixture comprises grinding and shaping said clay-based mixture to obtain a homogeneous mixture. Said mixing, grinding and shaping of the raw materials are preferably carried out in one and the same equipment. According to a preferred embodiment of the method of the invention, said clay-based mixture comprises from 10 to 25%, and preferably about 20%, of noble clay, expressed by weight relative to the total weight of dry matter.

Thus, according to a preferred embodiment of the method according to the invention, step a) of granulating the clay-based mixture comprises mixing the clay and said at least one material, grinding and shaping said mixture, to obtain a homogeneous mixture.

Granulation may be carried out by any means known to the person skilled in the art, especially by extrusion or by passage over a pelletizing disc.

During step b) of the method in accordance with the present invention, the aggregate is then dried, preferably to a moisture content of less than 20%. The drying step b) can be carried out by any means known to the person skilled in the art, preferably at low temperature, that is, at a temperature below 250° C., in order to avoid the release of organic elements and the bursting of the aggregates. The drying step reduces the moisture content of the aggregate and increases its hardness. It can be carried out in an adapted dryer. The energy required for drying may come from calories recovered during the cooling step d) after heat treatment of the aggregates, for example by means of a direct heat exchanger.

Thus, according to a particular and preferred embodiment of the method in accordance with the invention, said method further comprises a step of recovering calories from cooling the aggregates during step d).

After the drying step b), the aggregate is subjected, in step c), to a heat treatment in two successive sub-steps, at appropriate temperatures and under defined conditions, according to the method according to the invention.

This heat treatment enables extraction of heavy metals, production of synthesis gas, decomposition of sulphates and carbonates, destruction of pathogens, creation of porosity and partial vitrification.

The first heat treatment sub-step, or pyrolysis, consists in subjecting the aggregate to a temperature T1 of between about 900 and 1200° C., in a reducing atmosphere.

By “reducing atmosphere”, it is meant an atmosphere devoid of oxygen and comprising a gas chosen from carbon monoxide, volatile hydrocarbons, hydrogen or a combination of these gases. A reducing atmosphere is obtained, for example, by the substoichiometric combustion, with air, of the organic compounds present in the mixture.

The first heat treatment sub-step may be carried out by any suitable means known to the person skilled in the art. It is especially carried out in a furnace such as, for example, a rotary furnace in which the atmosphere is reducing. This step is preferably carried out under substoichiometric conditions. This step enables the production of a synthesis gas rich in carbon monoxide (CO) and volatile hydrocarbons (CxHy) and devoid of oxygen.

During this first heat treatment sub-step, heavy metals such as mercury (Hg), cadmium (Cd), zinc (Zn) and lead (Pb) are reduced and volatilize, partially or totally.

These metals are in gaseous form in the synthesis gas produced during the reaction. The main sulphates are decomposed and the sulphur compounds, as well as the chlorine compounds, are extracted in the gas phase.

The conditions used during this first heat treatment sub-step optimise the amounts of synthesis gas produced. The synthesis gas produced during this first sub-step can be directed especially towards a boiler, an engine or another device. It is possible to use the synthesis gas from the heat treatment step in an oxidising atmosphere to initiate the reaction of the heat treatment step in a reduced atmosphere.

The temperature T1 of the first heat treatment sub-step is between about 900 and 1200° C., preferably between about 950 and 1200° C., more preferably between about 1050 and 1150° C., and even more preferably between about 1110 and 1150° C.

This temperature range especially makes it possible to extract the sulphur compounds without oxidising them to sulphates.

The exact temperature of the first heat treatment sub-step depends on the clay-based mixture and on the composition of the synthesis gas possibly injected into the enclosure in which said heat treatment takes place.

The duration of the first heat treatment sub-step is generally between about 30 and 150 minutes, preferably between about 60 and 120 minutes, more preferably it is about 120 minutes.

The second heat treatment sub-step consists of combustion in an oxidising atmosphere at a temperature T2 of between about 1050 and 1300° C.

By “oxidising atmosphere”, it is meant an atmosphere comprising at least one oxidising agent, preferably oxygen (0₂). An oxidising atmosphere is obtained, for example, by over-stoichiometric combustion of methane with air, to give an atmosphere in which the proportion of oxygen is greater than 3%.

The second heat treatment sub-step can be carried out by any suitable means known to the person skilled in the art. It is especially carried out in a rotary furnace.

The temperature T2 of the second heat treatment sub-step is between about 1050 and 1300° C., preferably between about 1050 and 1150° C., more preferably between about 1110 and 1150° C., and even more preferably it is about 1125° C.

This second heat treatment sub-step completes the decomposition of the carbonates and the complete combustion of the organic compounds; metals such as iron (Fe), nickel (Ni) and chromium (Cr) can further react with each other to form insoluble spinel compounds. The decomposition of the organic compounds, sulphates and carbonates leads to a porous structure giving rise to a lightweight aggregate, that is, an aggregate preferably with a density of less than about 1. The high temperature of the reaction results in the ceramisation and partial vitrification of the materials, which gives the aggregates their hardness and mechanical strength.

The exact temperature of the second heat treatment sub-step depends on the melting temperature of the aggregates, which depends on the chemical composition of the clay-based mixture.

The duration of the second heat treatment sub-step is generally between about 30 and 150 minutes, preferably between about 60 and 120 minutes, more preferably it is about 60 minutes.

According to a particular embodiment of the method according to the invention, the temperature T1 is less than or equal to the temperature T2.

According to a more particular embodiment of the method according to the invention, T1 is equal to T2.

After the heat treatment of step c), an aggregate is obtained whose density is generally between about 0.6 and 1, and whose particle size is between 1 and 15 mm.

According to a particular embodiment of a method according to the invention, the combustion gases generated during the second heat treatment sub-step are injected into the enclosure in which the first heat treatment sub-step takes place.

During step d), the aggregates thus obtained can be cooled by any known and adapted means, especially by introduction into a cooler. Said cooler operates under ambient air. This step enables the aggregates to be cooled to a temperature below about 100° C. This cooling step also enables calories to be recovered, as the transfer of calories from the aggregates to the ambient air results in warming this air being from a temperature of about 15° C. to a temperature of about 250° C. The hot air thus produced can then be recovered, especially for use in the step of drying the aggregates prior to the heat treatment step c).

Implementation of the method according to the invention therefore results in a lightweight aggregate characterised by a density of less than 1. Said aggregate is also characterised by its spherical appearance and its hardness. Said aggregate is also characterised in that, by comparison with an aggregate taken before the heat treatment in two sub-steps of the method according to the invention, when it is subjected to a leaching test according to standard NF X 30-402-2, it is characterised by the absence or low level of release of organic pollutants and/or metallic pollutants, or the release of organic pollutants and/or metallic pollutants at a level compatible with the parameters defined for reclamation in road techniques or construction materials for example.

A lightweight aggregate obtained by the method according to the invention is particularly interesting for manufacturing materials such as: a draining material, a snow removal substrate, sand, an insulating material, an insulating lightweight building block, a green roof. A lightweight aggregate obtained by the method according to the invention is also particularly interesting for manufacturing construction materials such as lightweight concretes.

One object of the invention is therefore also a material comprising an aggregate obtained by a method according to the invention.

A second object of the invention is the use of an aggregate obtained by the method according to the invention in the construction, public works, landscaping or agricultural industries.

More particularly, one object of the invention is the use of an aggregate obtained by the method according to the invention for a road use, preferably selected from: a type 1 road use, a type 2 road use and a type 3 road use.

Type 1 road uses are uses of at most three metres high as a sub-base of roadways or shoulders of paved road structures, especially embankments under structures, sub-bases, base courses and binder courses. Type 2 road uses are uses of at most six metres in technical embankments associated with the road infrastructure or on the shoulder, as long as they are uses within covered road structures. They also include uses more than three metres thick and at most 6 metres high in the sub-base of roadways or shoulders of paved road structures. Type 3 road uses are not subject to any restrictions on implementation thickness. They are especially, for example, uses as a sub-base for a roadway or shoulder, for the construction of building site tracks, forest roads or towpaths.

### EXAMPLES

### Example 1: Preparation and Characterisation of Products Before Mixing

A clay-based mixture further comprising three types of sludge has been prepared, with the following respective proportions: WWTP sludge: 40%; dredging sediments, 20%; filter cake, 20%; noble clay, 20%.

An analysis of the leaching of each of the products intended to be incorporated into the mixture has been carried out. Table 2 below is a synthesis of the results of these analyses and an extrapolation of the values for the mixture.

TABLE 2

| | | | | | |
|---|---|---|---|---|---|
| Guide | | | Sludge | | |
| Values | | | from | Noble | |
| ISDI | Filter cake | Sediment | WWTP | clay | Mixture |

Leaching tests
standard NF X 30-402-2; L-S = 10 L/Kg, results expressed in mg/kg

| | | | | | | |
|---|---|---|---|---|---|---|
| Parameters | | | | | | |
| Arsenic (As) | 0.5 | 0.2 | 0.2 | 1 | 0.2 | 0.52 |
| Barium (Ba) | 20 | 0.29 | 0.15 | 3.35 | 0.87 | 1.61 |
| Cadmium (Cd) | 0.04 | 0.002 | 0.002 | 0.011 | 0.002 | 0.01 |
| Total chromium (Total | 0.5 | 0.1 | 0.1 | 0.1 | 0.1 | 0.1 |
| Cr) | | | | | | |
| Copper (Cu) | 2 | 0.7 | 0.2 | 50.3 | 0.2 | 20.34 |
| Mercury (Hg) | 0.01 | 0.001 | 0.001 | 0.003 | 0.001 | 0.01 |
| Molybdenum (Mo) | 0.5 | 0.156 | 0.055 | 1.95 | 0.045 | 0.84 |
| Nickel (Ni) | 0.4 | 0.1 | 0.1 | 4.48 | 0.1 | 1.86 |
| Lead (Pb) | 0.5 | 0.1 | 0.1 | 1.32 | 0.1 | 0.59 |
| Antimony (Sb) | 0.06 | 0.1 | 0.01 | 0.026 | 0.022 | 0.04 |
| Selenium (Se) | 0.1 | 0.01 | 0.02 | 0.85 | 0.031 | 0.36 |
| Zinc (Zn) | 4 | 0.2 | 0.2 | 8.39 | 0.2 | 3.48 |
| Chlorides (3) | 800 | 72.5 | 4870 | 1430 | 226 | 1605.7 |
| Fluorides | 10 | 5 | 7.12 | 5 | 8.82 | 6.19 |
| Sulphates (3) | 1000 | 14,900 | 3040 | 2160 | 1080.0 | 4668 |
| Phenol index | 1 | 0.5 | 0.5 | 5.72 | 0.5 | 2.59 |
| Total organic carbon | 500 | 10 | 130 | 62,000 | 50 | 24,860 |
| (TOC) on eluate | | | | | | |
| Soluble fraction (3) | 4000 | 23,500 | 14,400 | 159,000 | 2040 | 71,588 |
| (SF) | | | | | | |
| Tests on raw waste | | | | | | |
| Total organic carbon | 30,000 | 44,600 | 19,600 | 263,000 | 24,000 | 122,840 |
| (TOC) | | | | | | |
| Benzene, toluene, | 6 | 0.05 | 0.05 | 0.07 | 0.05 | 0.06 |
| ethylbenzene and | | | | | | |
| xylenes (BTEX) | | | | | | |
| Polychlorinated | 1 | 0.121 | 0.01 | 0.01 | 0.01 | 0.04 |
| biphenyls 7 congeners | | | | | | |
| (PCB) | | | | | | |
| Hydrocarbons (C10 to | 500 | 1300 | 220 | 1000 | 45 | 713 |
| C40) (HCT) | | | | | | |
| Polycyclic aromatic | 50 | 21 | 0.99 | 0.61 | 0.05 | 4.66 |
| hydrocarbons (PAH) | | | | | | |

It can be noticed that the results of the analyses of the raw waste leachates exceed some of the guide values defined in the standard.

### Example 2: Firing Tests

Each of the different components has first been weighed and then the different components have been mixed in a mixer. The clay-based mixture prepared, weighing about 30 kg, has then been air-dried to a moisture content of around 20%, expressed as % H₂O on dry matter. Moisture measurements have been carried out on a Mettler-Toledo infrared desiccator. 500 grammes of the basic mixture have then been ground to a fine powder in a Blender type mixer. Unwanted elements such as stones, sea shells and pieces of wood have been sieved out. The product obtained has been mixed again in the mixer, adding any different additives selected. While continuing mixing, the product has been hydrated to obtain a lump for making the aggregates. The aggregates obtained have then been dried in an electric oven at 120° C. for 24 hours. Once dry, a 500 g sample has been subjected to a heat treatment in two steps.

In a preliminary test, the sample has been successively subjected to two treatment steps: a first firing at 700° C. for 20-30 minutes, and then heat treatment for 60 minutes at 1075° C. Once the heat treatment carried out, the beads have been cooled in air. Leaching tests have been carried out in accordance with standard NF X30¬402-2 (NF EN 12457-2). Chemical analyses have then been carried out according to the recommendations cited in said standard. The results obtained before and after treatment have been compared, and the mean results are set forth in Table 3 below.

TABLE 3

| | | | |
|---|---|---|---|
| | Guide | Before | After |
| | values | treatment | treatment |
| Parameters | ISDI | Mean | Mean |

Leaching tests standard NF X 30-402-2;
L-S = 10 L/Kg. results expressed in mg/kg

| | | | |
|---|---|---|---|
| Arsenic (As) | 0.5 | 0.36 | 0.05 |
| Barium (Ba) | 20 | 0.85 | 1.52 |
| Cadmium (Cd) | 0.04 | 0.01 | 0.01 |
| Total chromium | 0.5 | 0.1 | 0.85 |
| (Total Cr) | | | |
| Copper (Cu) | 2 | 87.5 | 0.08 |
| Mercury (Hg) | 0.01 | 0.000 | 0.000 |
| Molybdenum (Mo) | 0.5 | 1.61 | 15.17 |
| Nickel (Ni) | 0.4 | 6.17 | 0.05 |
| Lead (Pb) b) | 0.5 | 0.46 | 0.09 |
| Antimony (Sb | 0.06 | 0.36 | 0.01 |
| Selenium (Se) | 0.1 | 0.45 | 0.18 |
| Zinc (Zn) | 4 | 5.90 | 0.03 |
| Chlorides (3) | 800 | 1770 | 96.83 |
| Fluorides | 10 | 5 | 1 |
| Sulphates (3) | 1000 | 12,450 | 14,433 |
| Phenol index | 1 | 0.6 | 0.11 |
| Total organic carbon | 500 | 14,500 | 1800 |
| (OCT: on eluate | | | |
| Soluble fraction (3) (FS) | 4000 | 62,400 | 24,833 |

The mean values obtained from the analyses performed after treatment exceed the thresholds admissible for ISDI and therefore would not be reclaimable. In particular, the high concentration of Mo, organic carbon and sulphates in the leachates is noted.

### Example 3: Sample Treated According to the Invention, First Series of Tests

A clay-based mixture as described in example 1 has been prepared. Aggregates have then been prepared as described in example 2. The aggregates obtained have then been dried in an electric oven at 120° C. for 24 hours. Once dry, a 500 g sample has been subjected to a heat treatment in two steps. The controlled atmosphere tests have been carried out in a tube furnace in a sealed quartz tube. If necessary, the atmospheres in the furnaces have been reconstituted using a mixture of pure gases (Air, CO, CO₂, N₂) produced by Air Liquide. The injection of the different gases is adjusted and controlled by micro-volumetric flowmeters that have been calibrated beforehand. Once the heat treatment carried out, the beads have been cooled in air.

Leaching tests have been carried out in accordance with standard NF X 30¬402-2 (NF EN 12457-2). Chemical analyses have then been carried out according to the conditions referenced in standard NF X 30-402-2. The results obtained have been compared with the acceptability thresholds for the reclamation of alternative materials in road engineering in the CEREMA Guide, which defines 3 types of use depending on the limit values obtained on leachates.

Road materials that can be used in type 1, 2 or 3 road uses are those for which the alternative materials going in their composition meet the limit values for type 1, 2 or 3 uses respectively. Table 4 below shows the acceptable values for type 1, type 2 or type 3 road uses, determined during leaching tests in accordance with standard NF X 30-0402-2; these values are expressed in mg/kg of dry matter. The results of the values obtained from the leaching tests on the raw sample, without additives or heat treatment, are set forth in Table 4 below, in the “Test 0” column.

TABLE 4

| | Type 1 | Type 2 | Type 3 | Test 0 |
|---|---|---|---|---|
| Arsenic (As) | 0.6 | 0.6 | 0.6 | 0.5 |
| Barium (Ba) | 36 | 25 | 25 | 0.5 |
| Cadmium (Cd) | 0.05 | 0.05 | 0.05 | 0.012 |
| Total chromium | 4 | 2 | 0.6 | 0.4 |
| (total Cr) | | | | |
| Copper (Cu) | 10 | 5 | 3 | 8.3 |
| Mercury (Hg) | 0.01 | 0.01 | 0.01 | 0.0004 |
| Molybdenum (Mo) | 5.6 | 2.8 | 0.6 | 0.91 |
| Nickel (Ni) | 0.5 | 0.5 | 0.5 | 2.1 |
| Lead (Pb) | 0.6 | 0.6 | 0.6 | 0.05 |
| Antimony (Sb) | 0.6 | 0.3 | 0.08 | 0.5 |
| Selenium (Se) | 0.5 | 0.4 | 0.1 | 0.05 |
| Zinc (Zn) | 5 | 5 | 5 | 6 |
| Chlorides (3) | 10,000 | 5000 | 1000 | 260 |
| Fluorides | 60 | 30 | 13 | 1 |
| Sulphates (3) | 10,000 | 5000 | 1300 | 27,000 |
| Phenol index | | | | 2 |
| Total organic carbon | 500 | 500 | 500 | 9600 |
| (TOC) on eluate | | | | |
| Soluble fraction (3) | | | | 67,000 |

These results show that the mixture obtained has many exceedances (figures indicated in bold) of the guide values and cannot be reclaimed as it is.

### Example 4: Sample Treated According to the Invention, First Series of Tests

In this example, the base mixture has been prepared according to the procedure described in example 1, in the form of aggregates according to example 2 and heat treated as indicated in example 3, with the addition of an additive in tests 4 and 6. This mixture has then been subjected to a heat treatment comprising a first sub-step carried out in a reducing atmosphere followed by a second sub-step carried out in an oxidising atmosphere (tests 4 to 6).

Test 4 has been carried out on the raw mixture in a mixed (oxidising/reducing) atmosphere. Test 5 has been carried out on the raw mixture to which 5% BaCO3 has been added in a mixed (oxidising/reducing) atmosphere. Test 6 has been carried out on the raw mixture to which 5% reducing agent (carbon) has been added, in a mixed (oxidising/reducing) atmosphere. Table 5 below describes the mixtures made (presence or not of additives) and the sequences used during the heat treatment.

TABLE 5

| Parameters | Test 4 | Test 5 | Test 6 |
|---|---|---|---|
| Additive | 5% BaCO3 | No | 5% BaCO3 |
| Atmosphere | Red/ox | Red/ox | Red/ox |
| Reducing atm. | | | |
| Temperature (° C.) | 1100 | 1125 | 1110 |
| Residence time (min) | 120 | 120 | 120 |
| Oxidising atm. | | | |
| Temperature (° C.) | 1100 | 1125 | 1110 |
| Residence time (min) | 30 | 30 | 30 |

The results are set forth in Table 6 below.

TABLE 6

| | Type 1 | Type 2 | Type 3 | Test 4 | Test 5 | Test 6 |
|---|---|---|---|---|---|---|
| Arsenic | 0.6 | 0.6 | 0.6 | 0.05 | 0.05 | 0.05 |
| (As) | | | | | | |
| Barium | 36 | 25 | 25 | 3.3 | 1.8 | 1.2 |
| (Ba) | | | | | | |
| Cadmium | 0.05 | 0.05 | 0.05 | 0.001 | 0.002 | 0.002 |
| (Cd) | | | | | | |
| Total | 4 | 2 | 0.6 | 0.26 | 0.26 | 0.43 |
| chromium | | | | | | |
| (total Cr) | | | | | | |
| Copper (Cu) | 10 | 5 | 3 | 0.46 | 0.04 | 0.12 |
| Mercury | 0.01 | 0.01 | 0.011 | 0.0033 | 0.0003 | 0.0003 |
| (Hg) | | | | | | |
| Molybdenum | 5.6 | 2.8 | 0.6 | 1.4 | 1.6 | 2.1 |
| (Mo) | | | | | | |
| Nickel (NI) | 0.5 | 0.5 | 0.5 | 0.05 | 0.05 | 0.05 |
| Lead (Pb) | 0.6 | 0.6 | 0.6 | 0.05 | 0.05 | 0.05 |
| Antimony | 0.6 | 0.3 | 0.08 | 0.05 | 0.05 | 0.05 |
| (Sb) | | | | | | |
| Selenium | 0.5 | 0.4 | 0.1 | 0.05 | 0.05 | 0.05 |
| (Se) | | | | | | |
| Zinc (Zn) | 5 | 5 | 5 | 0.05 | 0.05 | 0.05 |
| Chlorides (3) | 10,000 | 5000 | 1000 | 18 | 16 | 14 |
| Fluorides | 60 | 30 | 13 | 1 | 1 | 1 |
| Sulphates | 10,000 | 5000 | 1300 | 5200 | 2400 | 3700 |
| (3) | | | | | | |
| Phenol index | | | | 0.1 | 0.1 | 0.1 |
| CCT on | 500 | 500 | 500 | 36 | 10 | 20 |
| eluate | | | | | | |
| Soluble | | | | 22,000 | 12,000 | 13,000 |
| Fraction (3) | | | | | | |

Comparison of the results with the raw sample shows that whatever the treatment method, the metals, with the exception of Molybdenum, are no longer leachable after treatment.

Total organic carbon has fallen from a concentration of 9600 mg/kg to less than 20 mg/kg after treatment. The concentration of sulphates in the leachates has been divided by 6 to reach a mean of 4600 mg/kg. However, this value is still too high for the purposes of this study. The lowest sulphate concentration has been obtained in test No. 5 (2400 mg/kg). This result has been obtained on a raw sample (without additives) with a heat treatment sequence of 60 minutes at 1075° C. in a reducing atmosphere followed by 30 minutes of firing in an oxidising atmosphere at the same temperature. It can also be noticed that compared to tests 4 and 5, the addition of additive to the base mixture had no positive influence on the quality of the treatment.

### Example 4: Sample Treated According to the Invention, Second Series of Tests

In this example, the base mixture, as described in example 1, has first been subjected to a treatment in a reducing atmosphere, followed by a heat treatment in an oxidising atmosphere. The temperatures and residence times have varied according to the tests and are described in Table 7 below.

TABLE 7

| | Test 7 | Test 8 | Test 9 | Test 10 | Test 11 | Test 12 |
|---|---|---|---|---|---|---|
| Parameters | | | | | | |
| Additive | No | No | No | No | No | No |
| Atmosphere | Red/ox | Red/ox | Red/ox | Red/ox | Red/ox | Red/ox |
| Reducing | | | | | | |
| atm. | | | | | | |
| Temperature | 1075 | 1075 | 1100 | 1100 | 1125 | 1110 |
| (° C.) | | | | | | |
| Residence | 120 | 120 | 120 | 120 | 120 | 120 |
| time (min) | | | | | | |
| Oxidising | | | | | | |
| atm. | | | | | | |
| Temperature | 1075 | 1075 | 1100 | 1100 | 1125 | 1110 |
| (° C.) | | | | | | |
| Residence | 60 | 120 | 60 | 60 | 60 | 60 |
| time (min) | | | | | | |

Table 8 below is a synthesis of analyses obtained on leaching of products after treatment.

TABLE 8

| | Type | Type | Type | Test | Test | Test | Test | Test | Test |
|---|---|---|---|---|---|---|---|---|---|
| | 1 | 2 | 3 | 7 | 8 | 9 | 10 | 11 | 12 |
| Arsenic (As) | 0.6 | 0.6 | 0.6 | 0.05 | 0.05 | 0.05 | 0.05 | 0.05 | 0.05 |
| Barium (Ba) | 36 | 25 | 25 | 2.1 | 2.1 | 0.6 | 1.4 | 1.2 | 1 |
| Cadmium | 0.05 | 0.05 | 0.05 | 0.002 | 0.002 | 0.01 | 0.002 | 0.01 | 0.01 |
| (Cd) | | | | | | | | | |
| Total | 4 | 2 | 0.6 | 0.4 | 0.44 | 0.02 | 0.23 | 0.06 | 0.15 |
| chromium | | | | | | | | | |
| (Total Cr) | | | | | | | | | |
| Copper (Cu) | 10 | 5 | 3 | 0.03 | 0.03 | 0.03 | 0.03 | 0.02 | 0.03 |
| Mercury (Hg) | 0.01 | 0.01 | 0.01 | 0.0003 | 0.0003 | 0.0006 | 0.0003 | 0.0003 | 0.0003 |
| Molybdenum | 5.6 | 2.8 | 0.6 | 3.1 | 3.2 | 0.98 | 2.8 | 0.98 | 1.2 |
| (Mo) | | | | | | | | | |
| Nickel (Ni) | 0.5 | 0.5 | 0.5 | 0.05 | 0.05 | 0.05 | 0.05 | 0.05 | 0.05 |
| Lead (Pb) | 0.6 | 0.6 | 0.6 | 0.05 | 0.11 | 0.05 | 0.05 | 0.05 | 0.05 |
| Antimony | 0.6 | 0.3 | 0.08 | 0.05 | 0.05 | 0.05 | 0.05 | 0.05 | 0.05 |
| (Sb) | | | | | | | | | |
| Selenium | 0.5 | 0.4 | 0.1 | 0.05 | 0.05 | 0.05 | 0.05 | 0.05 | 0.05 |
| (Se) | | | | | | | | | |
| Zinc (Zn) | 5 | 5 | 5 | 0.02 | 0.02 | 0.02 | 0.1 | 0.02 | 0.02 |
| Chlorides (3) | 10000 | 5000 | 1000 | 17 | 16 | 830 | 380 | 540 | 510 |
| Fluorides | 60 | 30 | 13 | 1 | 1 | 1 | 1 | 1 | 1 |
| Sulphates (3) | 10000 | 5000 | 1300 | 3800 | 3300 | 1600 | 2800 | 1100 | 1300 |
| Index | | | | 0.1 | 0.1 | 0.1 | 0.1 | 0.1 | 0.1 |
| phenols | | | | | | | | | |
| TOC on | 500 | 500 | 500 | 10 | 10 | 10 | 10 | 10 | 10 |
| eluate | | | | | | | | | |
| Soluble | | | | 14,000 | 13,000 | 8100 | 12,000 | 7100 | 6700 |
| fraction | | | | | | | | | |

The results obtained confirm that the metals, with the exception of Molybdenum, are no longer leachable after treatment. Total organic carbon (TOO) has fallen from a concentration of 9600 mg/kg to less than 10 mg/kg after treatment. The concentration of sulphates in the leachates has been divided by 12 to reach a mean of 2,300 mg/kg after treatment. In tests 11 and 12, the sulphate concentration has fallen below the threshold of 1300 mg/kg, which is the current regulatory limit for reclamation into type 3 road materials, the most restrictive limit. These results have been obtained for a residence time of 120 minutes in a reducing atmosphere and 60 minutes in an oxidising atmosphere. The optimum temperature range appears to be between 1110 and 1125° C.

The implementation of a protocol comprising a two-phase heat treatment, with alternately a first phase of heat treatment in a reducing atmosphere, immediately followed by heat treatment in an oxidising atmosphere, greatly improves efficiencies compared with an absence of treatment or with the treatments described in the state of the art, such as especially those described in EP 1 571 135.

In particular, in a temperature range between 1110 and 1125° C., the sulphate conversion efficiency has made it possible to achieve sulphate levels in the leachates below the thresholds currently in force for the reclamation of aggregates in road engineering.

This study shows the ineffectiveness of adding different reagents on the treatment qualities. In particular, the addition of barium carbonate had no effect on the treatment of sulphates in the tests.

1-14. (canceled)

15. A method for preparing lightweight aggregates comprising at least the following steps of:
a) a step of granulating a clay-based mixture to obtain aggregates,
b) a step of drying the aggregates obtained, to obtain dried aggregates,
c) a step of heat treating the dried aggregates, said step comprising two successive sub-steps of:
i) a first heat treatment sub-step carried out in a reducing atmosphere at a temperature T1 of between 900 and 1200° C.,
ii) a second heat treatment sub-step carried out in an oxidising atmosphere at a temperature T2 of between 1050 and 1300° C., and
d) a step of cooling the aggregates.

16. The method according to claim 15, wherein said clay-based mixture comprises (i) between 10 and 25%, and preferably 20%, of noble clay material and (ii) at least one material obtained from sludge and/or industrial by-products, said material being selected from:
organic sludge, such as sewage plant sludge,
a dredging sediment
a filter cake, or
a combination of said materials,
said material having been freed from any foreign matter beforehand.

17. The method according to claim 16, wherein step a) of granulating the clay-based mixture comprises mixing the clay and at least one material obtained from sludge and/or industrial by-products, grinding and shaping said mixture to obtain a homogeneous mixture.

18. The method according to claim 15, wherein the clay-based mixture further comprises at least one additive.

19. The method according to claim 15, wherein the drying step b) is carried out at a temperature below 250° C.

20. The method according to claim 15, further comprising a step of recovering calories from the cooling of the aggregates during step d).

21. The method according to claim 20, wherein the energy required for the drying step b) comes at least in part from calories recovered during the cooling step d).

22. The method according to claim 15, wherein said first heat treatment sub-step is carried out at a temperature T1 of between 1050 and 1150° C., preferably between 1110 and 1150° C.

23. The method according to claim 22, wherein said first heat treatment sub-step is carried out for a duration of between 30 and 150 minutes, preferably for 120 minutes.

24. The method according to claim 15, wherein said first heat treatment sub-step is carried out in a rotary furnace in which the atmosphere is reducing.

25. The method according to claim 15, wherein said second heat treatment sub-step consists of oxidative combustion at a temperature T2 of between 1050 and 1150° C., preferably between 1110 and 1150° C., more preferably at about 1125° C.

26. The method according to claim 25, wherein said second heat treatment sub-step is carried out for a duration of between 30 and 150 minutes, preferably 60 minutes.

27. The method according to claim 15, wherein the temperature T1 is less than or equal to the temperature T2, preferably T1 is equal to T2.

28. A material for construction, public works, landscaping or agricultural industry, in particular for road use, comprising the aggregates obtained by the method according to claim 15.
